(19) United States
(12) Patent Application Publication
(10) Pub. No.: US 2024/0341275 A1
(43) Pub. Date: Oct. 17, 2024

(54) PET GROOMING KIT

(71) Applicant: Furme Technology LLC, Wilmington, DE (US)

(72) Inventor: Matthew Homa, Dorado, PR (US)

(73) Assignee: Furme Technology LLC, Wilmington, DE (US)

(21) Appl. No.: 18/750,757

(22) Filed: Jun. 21, 2024

Related U.S. Application Data
(63) Continuation-in-part of application No. 18/379,549, filed on Oct. 12, 2023.
(63) Continuation-in-part of application No. 18/376,232, filed on Oct. 3, 2023.
Application No. 18/379,549 is a continuation-in-part of application No. 18/130,770, filed on Apr. 4, 2023.
Application No. 18/376,232 is a continuation-in-part of application No. 18/130,770, filed on Apr. 4, 2023.
(60) Provisional application No. 63/442,326, filed on Jan. 31, 2023.

(51) Int. Cl. A01K 13/00; B26B 19/38; B26B 19/44

(52) U.S. Cl. CPC A01K 13/002; B26B 19/3833; B26B 19/44

(57) ABSTRACT

A pet grooming kit may include a plurality of tools, a base, a canister and a flexible hose. The base may have a base platform; a canister receiver; a housing having an exterior end face and an interior end face having a vacuum inlet; a vacuum system disposed in the housing; a handle; a hose coupling having an exterior port and an interior port; and a base latch. The canister may be removably attachable to the canister receiver and may have (i) a sidewall, (ii) a first end face, (iii) and a second end face, and (iv) a vacuum port. The flexible hose may have a tool-engaging end that is configured to releasably secure a tool or the base latch. The vacuum system may be configured to draw a vacuum through the flexible hose, the hose coupling, the vacuum port, the screen and the vacuum inlet.

### CROSS-REFERENCE TO RELATED APPLICATIONS

This application is a continuation-in-part of U.S. application Ser. No. 18/379,549, titled “Nail Grinder with Vacuum System and Method of Use,” filed on Oct. 12, 2023, and U.S. application Ser. No. 18/376,232, titled “Pet Grooming Tool with Vacuum System and Method of Use,” filed on Oct. 3, 2023; each of which is a continuation-in-part of U.S. application Ser. No. 18/130,770, titled “Pet Grooming Vacuum System,” filed Apr. 4, 2023, which claims priority to U.S. Application Ser. No. 63/442,326, titled “Pet Grooming Vacuum System,” filed Jan. 31, 2023. This application incorporates the entire contents of the foregoing application herein by reference.

### TECHNICAL FIELD

Various implementations relate generally to a pet grooming kit, and more specifically, to a low-noise vacuum grooming system that may be particularly suited for use in commercial and veterinary applications.

### BACKGROUND

Pets may be groomed regularly for cosmetic reasons. Various grooming tools may be employed to clean and brush pets. Common grooming tools include brushes, combs, trimmers, and the like. Such tools may be used to separate loose pet hair and other debris, such as dirt and pet dander, from the skin and coat of the pet. A vacuum source may be used to provide suction to remove the hair and debris picked up by or released from the grooming tools.

Conventional vacuum sources are often loud (e.g., 90-100 decibels) and may cause distress and anxiety in pets. In addition, the grooming process may be time-consuming, forcing pets to endure a high noise level for extended periods of time.

### SUMMARY

In some implementations, a pet grooming kit includes a plurality of tools, a base, a canister, and a flexible hose. The plurality of tools may include one or more unpowered tools and a powered vacuum clipper. The base may have a base platform; a canister receiver; a housing having a generally cylindrical shape that is characterized by a longitudinal housing axis, and that has an exterior end face and an interior end face having a vacuum inlet; a vacuum system disposed in the housing; a handle; a hose coupling having an exterior port and an interior port; and a base latch. The canister may be removably attachable to the canister receiver and may have (i) a sidewall that is generally cylindrical in shape and characterized by a longitudinal canister axis, (ii) a first end face, (iii) and a second end face, and (iv) a vacuum port. The flexible hose may have a vacuum-engaging end that is configured to be coupled to the exterior port and a tool-engaging end that is configured to either releasably secure one of a plurality of tools or the base latch. The canister may be attached to the canister receiver; the longitudinal canister axis may be colinear with the longitudinal housing axis; the vacuum port and interior port may be aligned; and the vacuum system may be configured to draw a vacuum through the flexible hose, the hose coupling, the vacuum port, the screen and the vacuum inlet. The first end face may be closed and the second end face may be hinged and include a screen that is rotatable between an open position in which contents of an interior of the canister are accessible and a closed position in which the second end face latches to the sidewall. The tool-engaging end may further include a tool-end power connection, and the flexible hose may include one or more conductors that electrically couple the tool-end power connection to a power source at the base.

The pet grooming kit may also include a caddy to organize and retain the plurality of tools.

A removable high-efficiency particulate air (HEPA) filter may be provided. A secondary filter including one or more of foam and polymer fibers may also be provided. The kit may include a flexible filter gasket that forms a seal between the sidewall and the second end face when the second end face is latched to the sidewall. The kit may include a flexible filter gasket that forms a seal between the HEPA filter, the second end face and the vacuum inlet when the canister is removably attached to the canister receiver.

The vacuum system may have at least a first suction mode in which the vacuum system emits noise at about 52 decibels or less, and a second suction mode that provides greater suction than the first suction mode and in which second suction mode the vacuum system emits noise at about 75 decibels or less.

The powered vacuum clipper may include a clipper head configured to cut hair and a vacuum port adjacent the clipper head configured to vacuum cut hair away from the clipper head and through the flexible hose.

The kit may further include a discharge port that is disposed inside the canister and fluidly coupled to the vacuum port and that has a deflector that is configured to deflect flow at an angle relative to flow through the vacuum port.

In some implementations, a pet grooming kit includes a plurality of tools, a base, a canister and a flexible hose. The base may have a base platform; a canister receiver; a housing having an exterior end face and an interior end face having a vacuum inlet; a vacuum system disposed in the housing; a handle; a hose coupling having an exterior port and an interior port; and a base latch. The canister may be removably attachable to the canister receiver and may have (i) a sidewall, (ii) a first end face, (iii) and a second end face, and (iv) a vacuum port. The flexible hose may have a vacuum-engaging end that is configured to be coupled to the exterior port and a tool-engaging end that is configured to either releasably secure one of a plurality of tools or the base latch. When the canister is attached to the canister receiver, the vacuum port and interior port may be aligned, and the vacuum system may be configured to draw a vacuum through the flexible hose, the hose coupling, the vacuum port, the screen and the vacuum inlet.

The housing may have a generally cylindrical shape and may be characterized by a longitudinal housing axis. The canister may generally cylindrical in shape and may be characterized by a longitudinal canister axis. When the canister is attached to the canister receiver, the longitudinal canister axis may be colinear with the longitudinal housing axis.

### BRIEF DESCRIPTION OF THE DRAWINGS

FIG. 1 illustrates an exemplary pet grooming kit.

FIGS. 2A-2D illustrate various details of a canister and base in the exemplary pet grooming kit of FIG. 1.

FIG. 3A illustrates details of an exemplary flexible hose.

FIGS. 3B-3C illustrate details of an exemplary base and hose.

FIGS. 4A and 4B illustrate details of exemplary filters.

FIG. 5 illustrates an exemplary tool caddy.

FIG. 6 illustrates detail of an exemplary powered tool.

### DETAILED DESCRIPTION

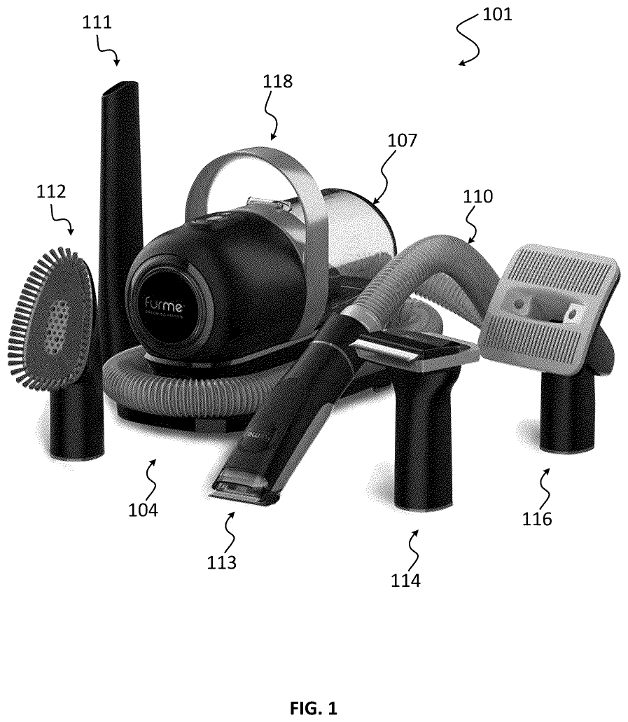

In some implementations, as shown in FIG. 1, a pet grooming kit 101 includes a base 104, a canister 107, a flexible hose 110, and a plurality of powered and unpowered tools—which may include one or more of a grooming wand 111, a grooming brush 112, a powered vacuum clipper 113, a de-shedding tool 114 and a grooming brush 116. A handle 118 may be provided to facilitate carrying of the overall kit 101.

The pet grooming kit 101 may be configured to be a stand-alone, easily carried kit that provides various tools necessary for a pet grooming professional to clip hair and fur; detangle the same; and remove clipped hair, dried skin, insects or other parasites.

In different implementations, different grooming kits may be particularly suited for different purposes—for example, some kits may be configured for use in general grooming operations, while other kits may be particularly suited for veterinary operations.

In various implementations, the base 104 includes an internally disposed vacuum system (not visible), to which the flexible hose 110 may be coupled on one end, with the other end being coupled to a tool (powered or unpowered), such as the powered vacuum clipper 113 or the de-shedding tool 114. The vacuum system may be configured to draw a vacuum through the flexible hose 110 and into and through the canister 107 to suck hair, clippings and other debris through the flexible hose 110 and into the canister 107. The canister 107 may be removed for cleaning.

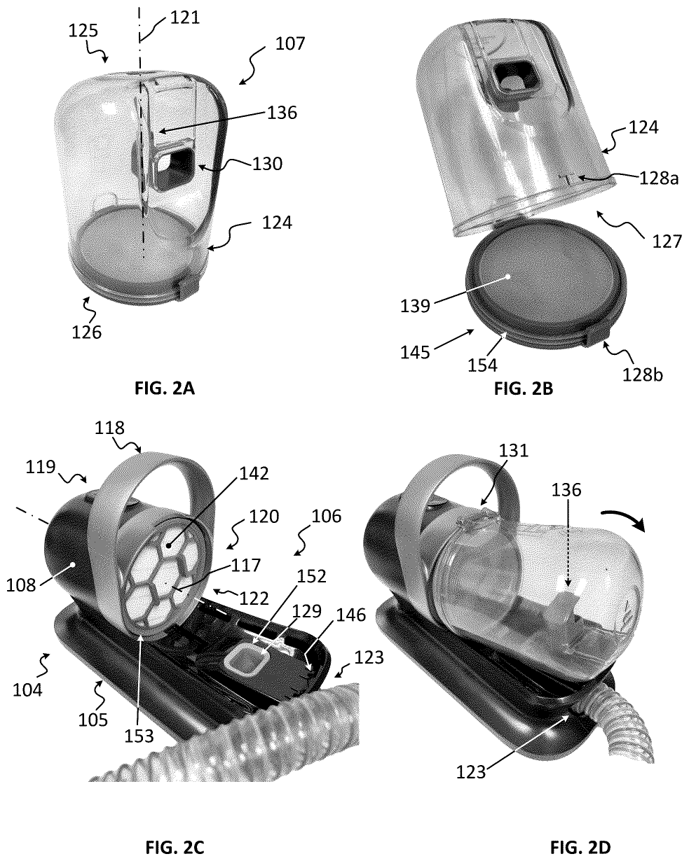

Turning to FIGS. 2A-2D, additional details of the exemplary canister 107 are illustrated and described. In some implementations, as shown, the canister 107 is generally cylindrical in shape, with a central longitudinal axis 121. The canister 107 includes a sidewall 124 that encloses an interior space 127, where hair, fur and other debris are collected; and a first end face 125 and a second end face 126. The first end face 125 may be closed. The second end face 126 may be hinged and may include a screen 139 that is rotatable between an open position (FIG. 2B), in which contents of the interior 127 of the canister are accessible, and a closed position (FIG. 2A), in which the second end face 126 latches to the sidewall 124 (e.g., with cooperating latch elements 128a and 128b).

Turning to FIGS. 2C and 2D, the base 104 includes a base platform 105, a canister receiver 106, and a housing 108. In some implementations, the housing 108 is generally cylindrical in shape and is characterized by a longitudinal housing axis 117. As shown, the housing 108 includes an exterior end face 119 and an interior end face 120 that includes a vacuum inlet 122. A vacuum system is disposed in the housing 108 (not visible in the figures). The base 104 further includes a handle 118 and a hose coupling 123, interior port 129 and a base latch 131.

Turning back to FIG. 2A, through the sidewall 124, a canister vacuum port 130 is provided, which interfaces with the interior port 129 (when the canister 107 is installed in the base 104), which is fluidly coupled to the flexible hose 110. The canister vacuum port 130 is coupled to a discharge port 136 on an interior side of the wall 124, and this discharge port 136 may be pointed away from (or not directly toward) a screen 139 on the bottom of the canister 107. As shown, the screen 139 is disposed adjacent a filter 142 when the canister 107 is installed on the base 104—such that the vacuum system in the base 104 draws a vacuum through the flexible hose 110, the hose coupling 123 (e.g., an exterior port), interior port 129, canister vacuum port 130 and discharge port 136, through the screen 139 and the filter 142. The screen 139 may be a durable material, such as metal, and may have a mesh-like construction that is designed to capture debris while facilitating airflow through itself.

In some implementations, as depicted in FIG. 2D, the canister 107 may be anchored in the base 104 (e.g., in receiver 106) by the base latch 131, and the canister 107 may then be rotated toward the base (as depicted in FIG. 2D), until the canister 107 is locked into place (e.g., with a friction fit and/or by tabs 146). Methods other than friction fits or locking tabs are possible for securing the canister 107 in other implementations (e.g., a twist-lock mechanical engagement, a sliding engagement, an electronic or electromagnetic engagement, etc.).

Various gaskets may be provided for sealing different components of the grooming kit 101. For example, a vacuum port sealing gasket 152 may be provided on the base 104 to provide an airtight or nearly airtight seal between the interior base vacuum port 129 and the canister vacuum port 130, when the canister 107 is installed on the base 104. A filter gasket 153 may be provided around a filter 142 to seal the filter 142 into the base 104 and to further seal the canister 107 to the base 104 at and around the screen 139. A screen gasket 154 may be provided to seal the latchable hinged panel 145 to the canister 107.

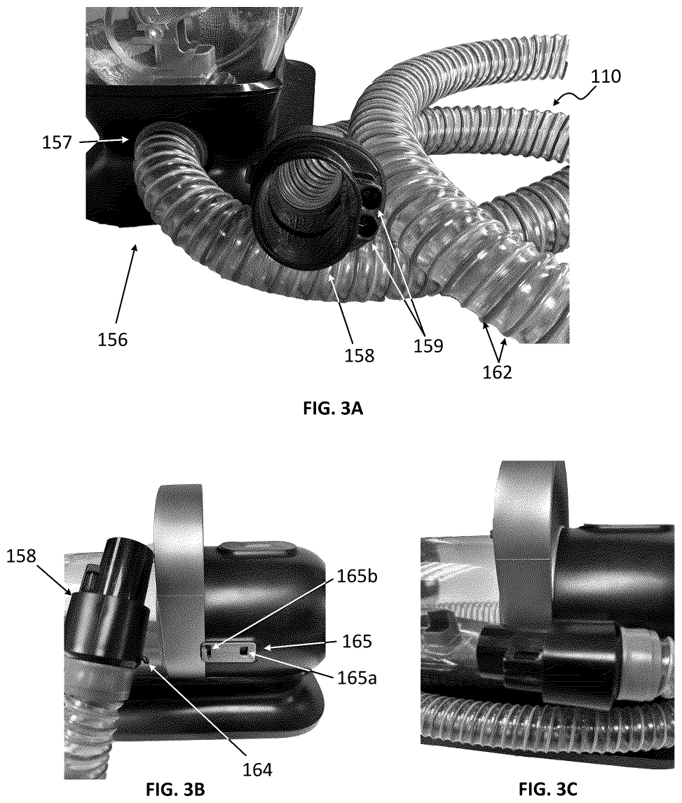

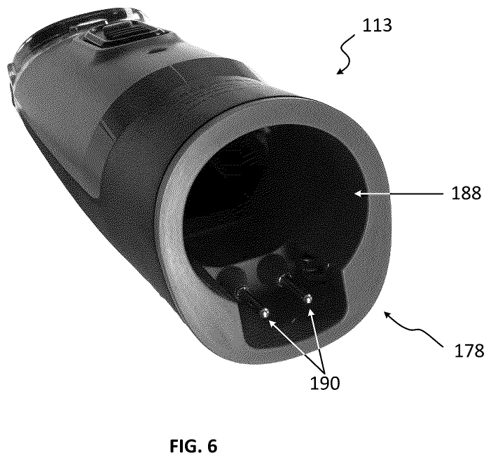

FIGS. 3A-3C illustrate additional details of an exemplary flexible hose 110. The flexible hose 110 includes a vacuum-engaging end 156 and a tool-engaging end 158. In some implementations, as shown, the vacuum-engaging end 156 may be attached in a non-removable manner to the base 104; in other implementations (not shown), the vacuum-engaging end 156 may be removably coupled to the base. Power connection(s) may be provided at each end—for example, a vacuum-end power connection 157 (not visible) and a tool-end power connection 159. The power connections may include pin/socket or blade/spade style connections, and they may facilitate electrical connection to mating connectors on the base 104 and on various powered tools. As shown, the power connection 159 includes sockets that are configured to mechanically and electrically mate with pin connectors on powered tools (e.g., prongs 190, shown in FIG. 6); but other types of mechanical and electrical connections are possible. Connecting the power connections 157 and 159 are conductors 162, which may be disposed in the flexible hose 110, as shown, or otherwise. Together, the vacuum-end power connection 157, conductors 162 and tool-end power connection 159, in conjunction with corresponding mating connectors on the base 104 and a powered tool, enable power to be supplied from the base 104 to a powered tool, such as the clipper 113 shown in FIG. 1.

In one implementation, the tool-engaging end 158 may include a detent 164 that is configured to be secured by a clip 165 on the base. That is, the detent 164 may be received by an aperture 165a in the clip 165, and a spring feature 165b of the clip may engage another portion of tool-engaging end 158. In this implementation, the flexible hose 110 may be secured at its vacuum-engaging end 156 by the base 104; the flexible hose 110 may be wrapped around the grooming kit 101; and the tool-engaging end 158 may be secured by the clip 165—such the grooming kit 101, including its flexible hose 101, can be secured together and easily transported (as shown in FIG. 3C).

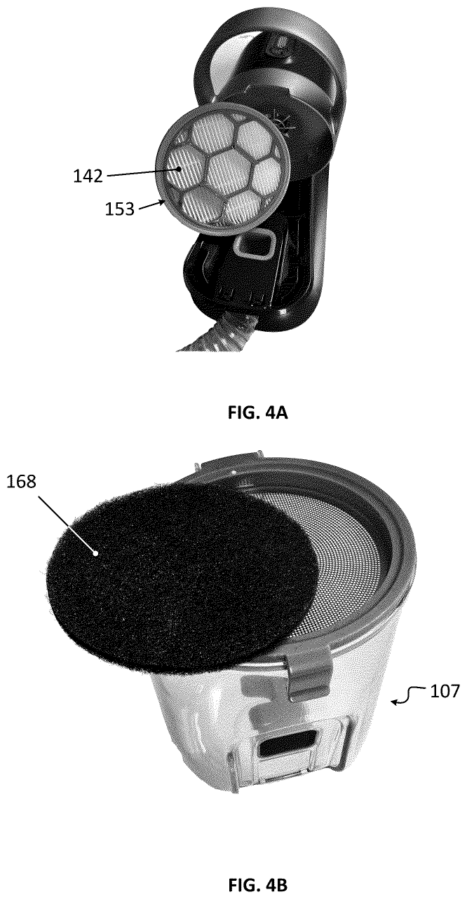

FIGS. 4A-4B illustrate additional detail of exemplary filters. In FIG. 4A, the filter 142 shown in FIG. 2C has been removed. In some implementations, the filter 142 is a high-efficiency particulate air (HEPA) filter, having a pleated construction and disposed in a supporting structure. As described with reference to FIG. 2C, a filter gasket 153 may be provided. In some implementations, a secondary filter 168 is provided (e.g., a sponge or foam filter)—which is shown removed from the canister 107 in FIG. 4B.

In some implementations, the specific design of the vacuum system (including its motor (not shown)) and the filter 142, gasket 153, and optional secondary filter 168, may suppress excessive noise that may be otherwise emitted from by the vacuum system. For example, the foregoing components may be designed and configured such that the vacuum system running in a first suction mode (e.g., a “low” setting) may emit noise at about 52 decibels or less (when measured at a standard test distance, such as, for example, 1 m from the device); the foregoing components may be designed and configured such that the vacuum system running in a second suction mode (e.g., a “high” setting) may emit noise at about 75 decibels or less. By configuring the grooming kit 101 to minimize its sound output, pets or other animals on which the grooming kit 101 is used may be less distressed or startled than by grooming kits or systems having greater sound output.

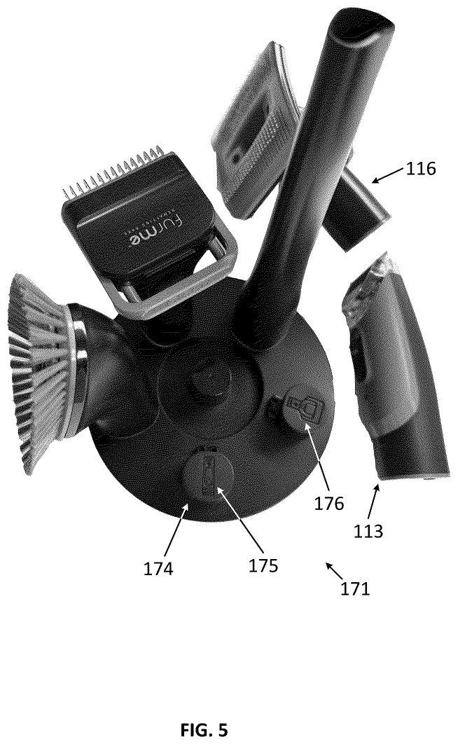

FIG. 5 illustrates a tool caddy 171 that may be included in some implementations. The caddy 171 may include posts (e.g., post 174) to receive an end of each tool that is configured to be coupled to the flexible hose 110. The post 174 may be tapered and have at its base substantially the same diameter and shape as an opening in each tool that is configured to receive the flexible hose 110. In this manner, each post 174 may secure a tool with a friction fit. In some implementations, as shown, indicia may be provided to provide users with an indication of where tools may be placed (e.g., indicia 175 for clippers 113; indicia 176 for the de-shed tool 116; etc).

FIG. 1 illustrates various tools, including unpowered vacuum tools, such as the grooming wand 111 and grooming brush 112. Each may be configured to be coupled to the flexible hose 110 for removal of hair, fur and other debris. Powered vacuum tools may be provided as well (e.g., clippers 113), and features of exemplary such tools are now described with reference to FIG. 6.

FIG. 6 illustrates additional detail of an exemplary powered vacuum tool, such as the clippers 113. As shown, the clippers 113 includes a hose-receiving end 178 and a vacuum port 188 that couples with the hose 110 (not shown in FIG. 6) to vacuum hair, fur, clippings or other material that is removed by the clippers 113 and vacuumed into the port 188 and flexible hose 110 for removal by the grooming kit 101. Power may be provided for a motor within the clippers 113 (not shown) via prongs 190, which may be configured to couple to the socket 159 shown in FIG. 3A.

Several implementations have been described with reference to exemplary aspects, but it will be understood by those skilled in the art that various changes may be made and equivalents may be substituted for elements thereof without departing from the contemplated scope. For example, as used herein, “about,” “approximately” or “substantially” may mean within 1%, or 5%, or 10%, or 20%, or 50%, or 100% of a nominal value; latches and release mechanisms may take different forms than described, and any mechanism may be employed that selectively engages and disengages through spring action, lever action, rotation action, friction fit, etc.; canisters may be other than cylindrical in shape or may have different axes or lack symmetry; gaskets and filters may be differently arranged or shaped and may include any suitable material; electrical connections may be made with pin/socket connectors, blade/spade connections, jack/plug connections, or other suitable connections; grooming blades (e.g., in trimmers) may be plastic, metal, ceramic or some combination thereof, and they may be configured to have different cutting angles to cut or trim hair or fur closer or farther from the skin; other tools, both powered and non-powered, may be provided; sealing gaskets may be made from any suitable material, such as rubber, silicone, etc.

Many other variations are possible, and modifications may be made to adapt a particular situation or material to the teachings provided herein without departing from the essential scope thereof. Therefore, it is intended that the scope include all aspects falling within the scope of the appended claims.

What is claimed is:

1. A pet grooming kit, comprising:
a plurality of tools comprising one or more unpowered tools and a powered vacuum clipper;
a base having a base platform; a canister receiver; a housing having a generally cylindrical shape, being characterized by a longitudinal housing axis, and having an exterior end face and an interior end face having a vacuum inlet; a vacuum system disposed in the housing; a handle; a hose coupling having an exterior port and an interior port; and a base latch;
a canister that is removably attachable to the canister receiver and that has (i) a sidewall that is generally cylindrical in shape and characterized by a longitudinal canister axis, (ii) a first end face, (iii) and a second end face, and (iv) a vacuum port; and
a flexible hose having a vacuum-engaging end that is configured to be coupled to the exterior port and a tool-engaging end that is configured to either releasably secure one of a plurality of tools or the base latch;
wherein, when the canister is attached to the canister receiver, the longitudinal canister axis is colinear with the longitudinal housing axis, the vacuum port and interior port are aligned, and the vacuum system is configured to draw a vacuum through the flexible hose, the hose coupling, the vacuum port, the screen and the vacuum inlet;
wherein the first end face is closed and the second end face is hinged, comprises a screen, and is rotatable between an open position in which contents of an interior of the canister are accessible and a closed position in which the second end face latches to the sidewall; and
wherein the tool-engaging end further including a tool-end power connection, the flexible hose including one or more conductors that electrically couple the tool-end power connection to a power source at the base.

2. The pet grooming kit of claim 1, further comprising a caddy to organize and retain the plurality of tools.

3. The pet grooming kit of claim 1, further comprising a removable high-efficiency particulate air (HEPA) filter.

4. The pet grooming kit of claim 3, further comprising a secondary filter comprising one or more of foam and polymer fibers.

5. The pet grooming kit of claim 3, further comprising a flexible filter gasket that forms a seal between the sidewall and the second end face when the second end face is latched to the sidewall.

6. The pet grooming kit of claim 3, further comprising a flexible filter gasket that forms a seal between the HEPA filter, the second end face and the vacuum inlet when the canister is removably attached to the canister receiver.

7. The pet grooming kit of claim 1, wherein the vacuum system has at least a first suction mode in which the vacuum system emits noise at about 52 decibels or less, and a second suction mode that provides greater suction than the first suction mode and in which second suction mode the vacuum system emits noise at about 75 decibels or less.

8. The pet grooming kit of claim 1, wherein the powered vacuum clipper comprises a clipper head configured to cut hair and a vacuum port adjacent the clipper head configured to vacuum cut hair away from the clipper head and through the flexible hose.

9. The pet grooming kit of claim 1, further comprising a discharge port that is disposed inside the canister and fluidly coupled to the vacuum port and that has a deflector that is configured to deflect flow at an angle relative to flow through the vacuum port.

10. A pet grooming kit, comprising:
a plurality of tools comprising one or more unpowered tools and a powered vacuum clipper;
a base having a base platform; a canister receiver; a housing having an exterior end face and an interior end face having a vacuum inlet; a vacuum system disposed in the housing; a handle; a hose coupling having an exterior port and an interior port; and a base latch;
a canister that is removably attachable to the canister receiver and that has (i) a sidewall, (ii) a first end face, (iii) and a second end face, and (iv) a vacuum port; and
a flexible hose having a vacuum-engaging end that is configured to be coupled to the exterior port and a tool-engaging end that is configured to either releasably secure one of a plurality of tools or the base latch;
wherein, when the canister is attached to the canister receiver, the vacuum port and interior port are aligned, and the vacuum system is configured to draw a vacuum through the flexible hose, the hose coupling, the vacuum port, the screen and the vacuum inlet;
wherein the first end face is closed and the second end face is hinged, comprises a screen, and is rotatable between an open position in which contents of an interior of the canister are accessible and a closed position in which the second end face latches to the sidewall; and
wherein the tool-engaging end further including a tool-end power connection, the flexible hose including one or more conductors that electrically couple the tool-end power connection to a power source at the base.

11. The pet grooming kit of claim 10, wherein the housing has a generally cylindrical shape and is characterized by a longitudinal housing axis.

12. The pet grooming kit of claim 11, wherein the canister is generally cylindrical in shape and is characterized by a longitudinal canister axis.

13. The pet grooming kit of claim 12, wherein when the canister is attached to the canister receiver, the longitudinal canister axis is colinear with the longitudinal housing axis.
